(19) United States
(12) Patent Application Publication
(10) Pub. No.: US 2008/0121662 A1
(43) Pub. Date: May 29, 2008

(54) System and method for dispensing an aseptic food product from a container

(76) Inventor: John P. Gehl, Nashotah, WI (US)

Correspondence Address: PATENTS+TMS, P.C., 2849 W. ARMITAGE AVE., CHICAGO, IL, 60647, US

(21) Appl. No.: 11/605,097

(22) Filed: Nov. 28, 2006

(51) Int. Cl. B65D 37/00; B67D 5/62

(52) U.S. Cl. 222/214; 222/146.2

(57) ABSTRACT

A system and a method dispense an aseptic food product from a container within a housing from a hose of the container. The hose extends through a clamping device located adjacent to the container and the housing. The clamping device has rollers and a block and/or a stopper to clamp the tube closed at one or more positions on the tube. The clamping device moves from an open position to a closed position for inserting the hose into and/or removing the hose from the clamping device. In the closed position, the clamping device maintains the sterility of and/or prevents contamination of the fluid. The tube prevents and/or minimizes growth and/or migration of microorganisms within the tube and/or the container. The fluid and/or the container are sterile and/or uncontaminated for dispensing the fluid at room temperature. The housing has a temperature element adjacent to the clamping device for heating and/or for cooling the hose between the clamping device and a tip of the hose for dispensing the fluid via the tip of the hose.

### BACKGROUND OF THE INVENTION

The present invention generally relates to a system and method for dispensing an aseptic food product from a container. More specifically, the present invention relates to a system and a method for dispensing an aseptic food product from a container which may have a clamping device located between the container and a tip of a hose. The hose may be, for example, an antimicrobial hose or a non-microbial hose. The clamping device may have rollers and/or a wedge block which may pinch and/or may clamp the hose at more than one position between the container and the tip of the hose. The rollers and/or the wedge block may prevent back flow of the fluid into the container and/or migration of bacteria, microbes, fungus and/or mildew into the container. As a result, the container may be maintained as a closed system and/or may remain sterile for dispensing the fluid via the hose and/or the clamping device. The hose may have antimicrobial properties and/or antibacterial properties to prevent growth and/or migration of the bacteria, the microbes, the fungus and/or the mildew within the hose and/or into the container. As a result, the clamping device and/or the hose may maintain sterility of the container and/or may prevent the fluid and/or the container from being contaminated by the bacteria, the microbes, the fungus and/or the mildew.

It is generally known that, for example, a beverage is dispensed by and/or is served to a customer from a dispenser. The dispenser may have a reservoir and a hose. The beverage is, for example, a low acid aseptic liquid food product, a dairy-based beverage and/or the like. The reservoir is sterilized by hydrogen peroxide, by steam or by exposure to radiation prior to filling the reservoir with the beverage and/or sealing the reservoir. After sealing the reservoir, the reservoir is a closed system which maintains the sterility of the beverage within the reservoir. Often, the reservoir has an outlet that must be opened or removed from and/or cut away from the reservoir prior to attaching the hose to the reservoir for dispensing the beverage from the dispenser. The reservoir is an open system after opening the outlet and/or removing the outlet from the reservoir, and the reservoir and the beverage are no longer sterile.

Traditionally, the beverage must be served and/or must be dispensed from the open system or the reservoir at a temperature below forty (40) degrees Fahrenheit (hereinafter “° F.”) or above one-hundred forty (140) ° F. The beverage must be served and/or must be dispensed from the open system or the reservoir at the temperature to prevent contamination from bacteria, microbes, fungus and/or the like. Serving and/or dispensing the beverage at the temperature provides a safe beverage which is suitable for consumption by the customer. However, the dispenser must have a refrigeration unit or a heating coil to dispense and/or to serve the beverage at the temperature for maintaining a safe beverage for consumption by the customer. As a result, the dispenser is expensive and/or is complex to manufacture, to operate and/or to repair because of the refrigeration unit and/or the heating coil which is required to serve the beverage at the temperature for consumption by the customer.

Often, the heating coil must heat the beverage for a duration of time, such as, for example, thirty (30) minutes before the beverage reaches the temperature above one-hundred and forty (140) ° F. The duration of time required to heat the beverage to the temperature with the heating coil is costly and consumes a large amount of energy. Moreover, the duration of time required to heat the beverage to the temperature is inconvenient to the customer and/or an operator of the dispenser.

Bacteria, microbes and/or fungus may grow within the hose which releases and/or dispenses the beverage from the open system or the reservoir. The hose may require flushing and/or cleaning with hot water to remove any bacteria, microbes and/or fungus that have grown and/or migrated within the hose. However, the dispenser must have a water source to provide the water for flushing the hose and a drain to remove the water and the bacteria, the microbes and/or the fungus from the hose and the dispenser. As a result, the dispenser is expensive to manufacture, to operate and/or to repair because of costs associated with incorporating a water source and/or a drain into the dispense to flush and/or to clean the hose for serving and/or dispensing the beverage.

A need, therefore, exists for a system and a method for dispensing an aseptic low acid food product from a container. Additionally, a need exists for a system and a method for dispensing an aseptic food product from a container which may have a hose, clamping device, rollers and/or a wedge block to maintain sterility of the container and/or the fluid. Further, a need exists for a system and a method for an aseptic food product from a container which may release the fluid at room temperature without requiring a refrigeration unit and/or a heating coil. Still further, a need exists for a system and a method for dispensing an aseptic food product from a container which may prevent growth and/or migration of bacteria, microbes, fungus and/or mildew within an antimicrobial hose and/or into the container. Moreover, a need exists for a system and a method for dispensing an aseptic food product from a container which may not require a hot water flush to remove bacteria, microbes, fungus and/or mildew from an antimicrobial hose. Furthermore, a need exists for a system and a method for dispensing an aseptic food product from a container which may not require a water source and/or a drain to flush and/or to clean an antimicrobial hose for releasing the fluid from a container. Additionally, a need exists for a system and a method for dispensing an aseptic food product from a container which may have a heating element for heating the fluid between a clamping device and a tip of a antimicrobial hose.

### SUMMARY OF THE INVENTION

The present invention generally relates to a system and a method for dispensing an aseptic food product from a container. The system may have a hose extending from the container through a clamping device which may have rollers and/or a wedge block for pinching and/or for clamping the hose at one or more positions. The hose may be, for example, an antimicrobial hose or a non-microbial hose. The clamping device may prevent back flow of the fluid from the clamping device into the container to maintain sterility of the container and/or the fluid. As a result, the fluid may be dispensed from the system with and/or without heating or cooling the fluid within the container and/or within the hose. The hose may be made from a material which may prevent growth of bacteria, microbes, fungus and/or mildew within the hose to maintain a low bacteria count within the fluid released from the container. A heating element or a cooling element may be connected to the clamping device and/or the hose for heating or for cooling, respectively, the hose between the clamping device and a tip of the hose for dispensing the fluid from the tip of the hose.

To this end, in an embodiment of the present invention, a system for dispensing a fluid is provided. The system has a container having exterior walls defining an interior wherein the fluid is aseptically stored within the interior of the container wherein the container has a hose having a length defined between the exterior walls of the container and a tip of the hose. The hose extends outwardly with respect to the exterior walls of the container wherein the fluid is dispensable from the interior of the container via the hose. The system has a clamping device connected to the hose between the exterior walls of the container and the tip of the hose wherein the clamping device has a length defined between a first end and a second end. The first end of the clamping device is adjacent to the container wherein the hose of the container extends through the clamping device outwardly with respect to the second end of the clamping device. Moreover, the clamping device closes the hose at a position within the clamping device wherein the clamping device dispenses a portion of the fluid from the tip of the hose and further wherein the fluid is aseptic.

In an embodiment, the fluid is a liquid food product, a dairy-based beverage or a coffee-based beverage.

In an embodiment, the system has a housing connected to the clamping device wherein the housing has an interior which is sized to receive the container.

In an embodiment, the system has a heating element connected to the hose wherein the heating element heats the fluid dispensed from the hose.

In an embodiment, the system has an outlet located between the interior of the container and the hose wherein the fluid is dispensed from the interior of the container via the outlet.

In an embodiment, the hose is made from an antimicrobial material.

In another embodiment of the present invention, a method for dispensing a fluid is provided. The method has the step of providing a container having exterior walls defining an interior wherein the exterior walls have an outlet wherein the interior of the container is accessible via the outlet wherein the fluid is aseptically stored within the interior of the container. Further, the method has the step of connecting a hose to the outlet of the container wherein the hose has a length defined between a first end and a second end wherein the first end of the hose is adjacent to the outlet. Still further, the second end of the hose extends outwardly with respect to the exterior walls of the container. Moreover, the fluid is dispensable from the interior of the container via the hose wherein the hose prevents contamination of the fluid.

In an embodiment, the method has the step of opening the second end of the hose wherein the fluid within the hose and the interior of the container is aseptic.

In an embodiment, the method has the step of changing a temperature of the hose between the first end of the hose and the second end of the hose.

In an embodiment, the hose is made from an antimicrobial material.

In an embodiment, the method has the step of dispensing a first portion of the fluid within the hose via the second end of the hose wherein the fluid is aseptic.

In an embodiment, the method has the step of connecting a clamping device to the hose wherein the clamping device is located between the first end of the hose and the second end of the hose.

In an embodiment, the method has the step of connecting a housing to the container wherein the housing has an interior which is sized to receive the container.

In an embodiment, the method has the step of closing the hose at a position which is located between the first end of the hose and the second end of the hose.

In another embodiment of the present invention, a method for dispensing a fluid from a container wherein the container has exterior walls defining an interior of the container is provided. The container has an outlet wherein the fluid exits the interior of the compartment via the outlet wherein the fluid is a food product which is aseptically stored within the interior of the container. The method has the step of connecting a hose to the outlet of the container wherein the hose has a length defined between a first end and a second end wherein the first end of the hose is adjacent to the container. Additionally, the second end of the hose extends outwardly with respect to the outlet of the container wherein the second end of the hose is open and further wherein the fluid is dispensable via the second end of the hose. Further, the method has the step of closing the hose at a point along the length of the hose wherein the point is located between the first end of the hose and the second end of the hose. Moreover, the method has the step of dispensing a portion of the fluid within the hose via the second end of the hose wherein the fluid within the hose and the interior of the container is aseptic.

In an embodiment, the method has the step of connecting a clamping device to the hose wherein the clamping device dispenses the fluid from the hose.

In an embodiment, the hose is made from an antimicrobial material.

In an embodiment, the method has the step of closing the second end of the hose wherein the second end of the hose prevents the fluid from exiting the hose.

In an embodiment, the method has the step of connecting a housing to the container wherein the housing has an interior which is sized to receive the container.

In an embodiment, the method has the step of emptying the fluid from the interior of the container via the hose.

It is, therefore, an advantage of the present invention to provide a system and a method for dispensing an aseptic food product from a container which may have a clamping device for pinching and/or for clamping a hose at more than one position between a tip of the hose and a container of the fluid.

Another advantage of the present invention is to provide a system and a method for dispensing an aseptic food product from a container which may have a clamping device for releasing the fluid from a container to prevent back flow of the fluid into the container.

And, another advantage of the present invention is to provide a system and a method for dispensing an aseptic food product from a container which may have a clamping device to maintain sterility of the container and the fluid in the container.

Yet another advantage of the present invention is to provide a system and a method for dispensing an aseptic food product from a container which may prevent growth of and/or migration of bacteria, microbes, mildews and/or fungus within an antimicrobial hose, a non-microbial hose and/or a container of the fluid.

A further advantage of the present invention is to provide a system and a method for dispensing an aseptic food product from a container which may serve and/or dispense the fluid for complying with health regulations from a government agency and/or an entity.

Moreover, an advantage of the present invention is to provide a system and a method for dispensing an aseptic food-product from a container with or without a refrigeration unit and/or a heating coil for cooling or to heating, respectively, the fluid prior to release from a container.

And, another advantage of the present invention is to provide a system and a method for dispensing an aseptic food product from a container which may dispense low acid aseptic liquid food products, dairy-based beverages with or without a heating coil and/or a refrigeration unit.

Yet another advantage of the present invention is to provide a system and a method for dispensing an aseptic food product from a container without a hot water flush of a hose to remove bacteria, microbes, fungus and/or mildew from the hose for maintaining sterility of the fluid.

Another advantage of the present invention is to provide a a system and a method for dispensing an aseptic food product from a container without a water source and/or a drain to flush and/or to clean an antimicrobial hose or a non-microbial hose with hot water for maintaining sterility of the fluid.

Yet another advantage of the present invention is to provide a system and a method for dispensing an aseptic food product from a container which may heat or may cool a portion of a hose between a clamping device and a tip of the hose.

A still further advantage of the present invention is to provide a system and a method for dispensing an aseptic food product from a container which may have a heating element or a refrigeration unit between a clamping device and a nozzle of a hose for killing bacteria, fungus, microbes and/or mildew within the hose.

Moreover, an advantage of the present invention is to provide a system and a method for dispensing an aseptic food product from a container which is inexpensive to manufacture, to operate and/or to repair.

And, another advantage of the present invention is to provide a system and a method for dispensing an aseptic food product from a container which may have a peristaltic pump, a clamping device, a refrigeration unit and/or a heating element to maintain sterility of the fluid between a container of the fluid and a nozzle of a hose.

Additional features and advantages of the present invention are described in, and will be apparent from, the detailed description of the presently preferred embodiments and from the drawings.

### BRIEF DESCRIPTION OF THE DRAWINGS

FIG. 1 is an exploded perspective view of a system for dispensing an aseptic food product from a container in an embodiment of the present invention.

FIG. 2 is a front plan view of a system for dispensing an aseptic food product from a container in an embodiment of the present invention.

FIG. 3 is a front plan view of a system for dispensing an aseptic food product from a container in an embodiment of the present invention.

### DETAILED DESCRIPTION OF THE PREFERRED EMBODIMENTS

The present invention generally relates to a system and a method for dispensing an aseptic food product from a container. The system may have a housing sized for storing the container which may contain the fluid. A hose may be connected to the container of the fluid within the housing for dispensing and/or for releasing the fluid from a tip of the hose. The hose may be, for example, an antimicrobial hose or a non-microbial hose. The hose may extend through and/or may pass through a clamping device located adjacent to the container and the housing. The clamping device may have rollers and a block to clamp and/or to pinch the tube closed at more than one position within the clamping device. The clamping device may move from an open position to a closed position for inserting the hose into the clamping device and/or for removing the hose from the clamping device. In the closed position, the clamping device may maintain the sterility of and/or prevent contamination of the fluid, the hose and/or of the container.

Additionally, the clamping device may prevent back flow of the fluid into the container. In an embodiment, the system may not have the clamping device and gravitational forces may prevent back flow of the fluid from the hose into the container. Further, the clamping device may prevent growth and/or may prevent migration of bacteria, microbes, fungus and/or mildew within the container and/or the tube located between the clamping device and the container. In an embodiment, the tube may have antimicrobial properties and/or antibacterial properties to prevent and/or to minimize growth and/or migration of bacteria, microbes, fungus and/or mildew within the tube and/or the container. As a result, the fluid, the hose and/or the container may be sterile and/or uncontaminated for dispensing and/or for releasing the fluid with or without heating of and/or cooling of the fluid. In an embodiment, a heating element and/or a refrigeration unit may be connected to the housing and/or may be located adjacent to the clamping device and/or the hose. The heating element and/or the refrigeration unit may heat and/or may cool, respectively, a portion of the hose between the pump and the tip of the hose for dispensing and/or for releasing the fluid from the tip of the hose.

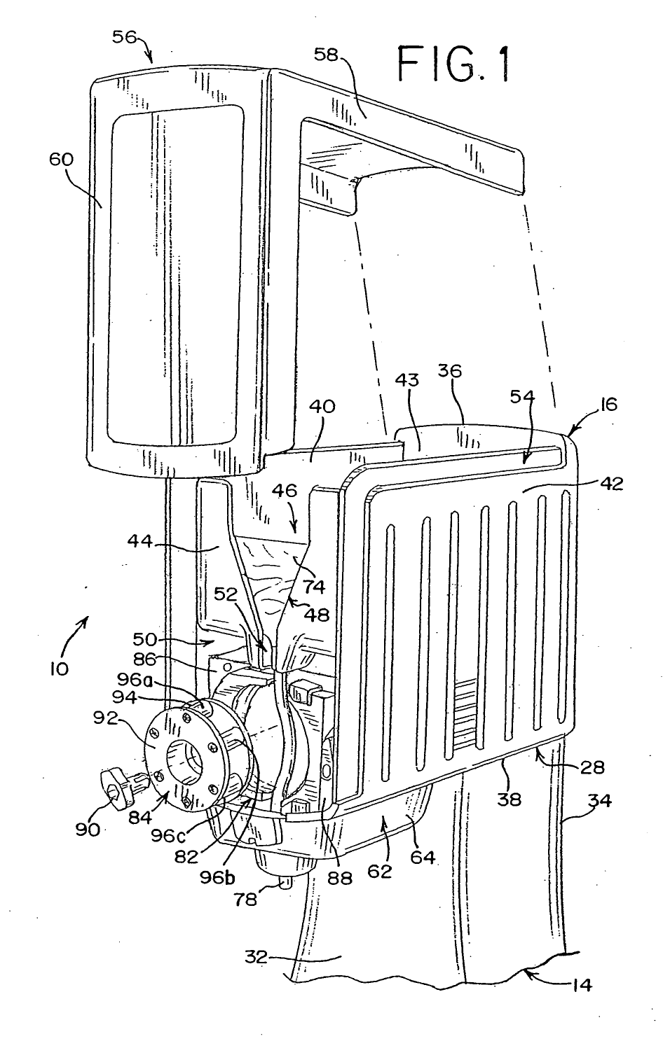

Referring now to the drawings wherein like numerals refer to like parts, FIGS. 1-3 illustrate a system 10 for dispensing, for serving and/or for releasing a fluid (not shown in the figures) in an embodiment of the present invention. The system 10 may have a base 12, a support 14 and/or a housing 16. The support 14 may be located between and/or may connect the base 12 and the housing 16. The base 12 may have a bottom side 18, a front side 20, a top side 22 and/or a recession 24 within the top side 22. A button 26 may be located on and/or may extend outwardly from the front side 20 of the base 12. The button 26 may activate and/or may deactivate the system 10 to serve, to dispense and/or to release the fluid.

The support 14 may have a top end 28 and/or a bottom end 30 which is located opposite to the top end 28 as shown in FIGS. 1 and 3. The support 14 may have a front side 32 and/or a back side 34 which may be located opposite to the front side 32. The bottom end 30 of the support 14 may be attached to and/or may be connected to the top side 22 of the base 12. The front side 32 of the support 14 may be adjacent to the top side 22 of the base 12. The top end 28 of the support 14 may extend outwardly with respect to the top side 22 of the base 12. In an embodiment, the support 14 may be integrally formed with the base 12.

The housing 16 may have a top end 36 and a bottom end 38 which is located opposite to the top end 36. The housing 16 may have a first wall 40, a second wall 42, a back wall 43 and/or a front wall 44 extending from the bottom end 38 to the top end 36 of the housing 16. As a result, the bottom end 38, the first wall 40, the front wall 44, the back wall 43 and/or the second wall 42 may define a compartment 46 of the housing 16 as shown in FIG. 3. The bottom end 38 of the housing 16 may be connected to and/or may attached to the top end 28 of the support 14. As a result, the housing 16 may be connected to and/or may be attached to the base 12 via the support 14. The bottom end 38 of the housing 16 may be positioned and/or may be located above the top side 22 of the base 12 and/or above the recession 24 of the base 12. In an embodiment, the housing 16 may be integrally formed with the base 12 and/or the support 14.

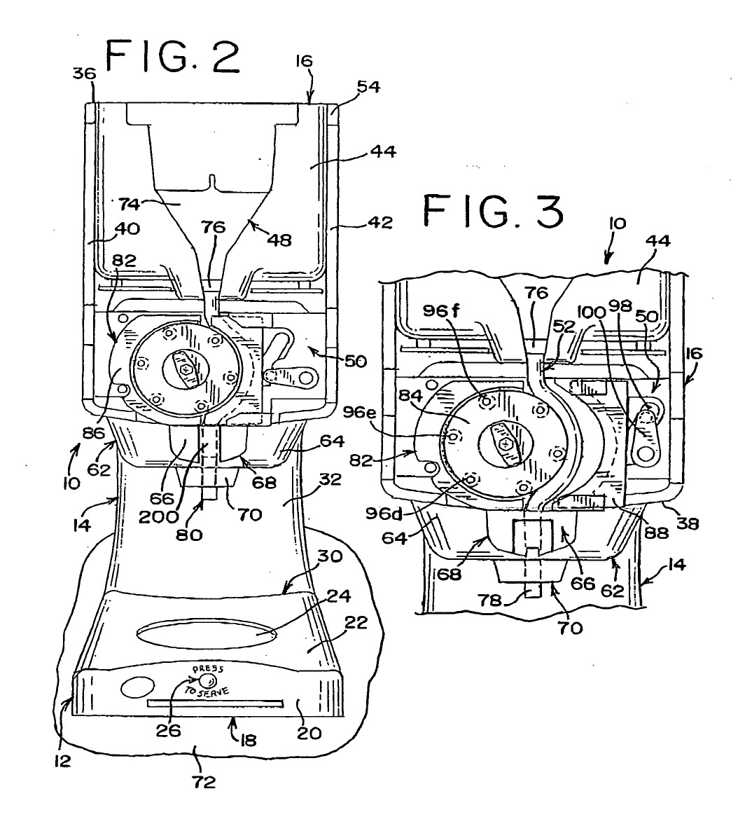

The front wall 44 of the housing 16 may have a slot 48 for accessing the compartment 46 of the housing 16 as shown in FIGS. 1 and 2. The slot 48 may be, for example, Y-shaped, U-shaped, rectangular, oval and/or the like. The front wall 44 may be removably attached to the first wall 40, the second wall 42 and/or the bottom end 38 of the housing 16. In an embodiment, the front wall 44 may be integrally formed with the first wall 40, the second wall 42, the bottom end 38 and/or the back wall 43 of the housing 16.

The front wall 44, the first wall 40, the second wall 42 and/or the bottom end 38 of the housing 16 may define an interior 50 of the housing 16 as shown in FIGS. 1-3. The interior 50 may be located between the front wall 44 and/or the compartment 46 and the bottom end 38 of the housing 16. The slot 48 of the front wall 44 may extend between and/or may be located between the compartment 46 of the housing 16 and the interior 50 of the housing 16. The bottom end 38 of the housing 16 may have an opening 52 for accessing the interior 50 of the housing 16 as shown in FIGS. 1 and 3. The opening 52 of the housing 16 may be aligned with and/or may be located in a position corresponding to the recession 24 of the base 12 when the support 14 and the housing 16 may be attached to and/or may be connected to the base 12.

The housing 16 may have a groove 54 on the first wall 40 and/or the second wall 42 which may be sized to receive a lid 56 of the housing 16 as shown in FIGS. 1 and 2. The lid 56 may have a first wall 58 and/or a second wall 60 which may be connected to and/or may be attached to the first wall 58. The lid 56 may be inserted into the groove 54 of the housing 16 for connecting and/or for attaching the lid 56 to the housing 16. As a result, the lid 56 may enclose, may surround and/or may cover the compartment 46 of the housing 16 and/or the interior 50 of the housing 16. The lid 56 may be removed from and/or may be separated from the housing 16 for accessing the compartment 46 of the housing 16 and/or for accessing the interior 50 of the housing 16. In an embodiment, the first wall 58 may be integrally formed with the second wall 60 of the lid 56.

The housing 16 may have a cap 62 which may be attached to and/or may be connected to the bottom end 38 of the housing 16 as shown in FIGS. 1-3. The cap 62 may have exterior walls 64 which may extend outwardly with respect to the bottom end 38 of the housing 16. The exterior walls 64 of the cap 62 may define an interior 66 of the cap 62. The cap 62 may be located between and/or may be positioned between top side 22 of the base 12 and the bottom end 38 of the housing 16. The interior 66 of the cap 62 may be located adjacent to the opening 52 of the housing 16 and/or the slot 48 at the bottom end 38 of the housing 16. As a result, the interior 50 of the housing 16 may be accessed via the interior 66 of the cap 62 and/or the opening 52 of the housing 16. In an embodiment, the cap 62 may be integrally formed with the housing 16 of the system 10.

The housing 16 may have a window 68 and/or a nozzle 70 as shown in FIGS. 2 and 3. The window 68 may extend through the exterior walls 64 of the cap 62 to the interior 66 of the cap 62. As a result, the interior 66 of the cap 62 may be accessed via the window 68 of the cap 62. The nozzle 70 of the cap 62 may be attached to and/or may be connected to the exterior walls 64 of the cap 62. The nozzle 70 may be located between and/or may be positioned between the exterior walls 64 of the cap 62 and the recession 24 on the top side 22 of the base 12. The interior 66 of the cap 62 may be accessed via the nozzle 70 of the cap 62. In an embodiment, the nozzle 70 may be integrally formed with the cap 62 of the housing 16.

A user (not shown in the figures) may position, may mount and/or may station the base 12 of the system 10 on a fixture 72 for dispensing, for serving and/or for releasing the fluid from the system 10 as shown in FIG. 2. As a result, the system 10 may be connected to and/or may be attached to the fixture 72. The support 14 and/or the housing 16 of the system 10 may extend outwardly with respect to the fixture 72. As a result, the system 10 may be displayed on and/or may be mounted on the fixture 72. The fixture 72 may be, for example, a table, a desk, a shelf, a rack, a refrigerator and/or the like. The present invention should not be deemed as limited to a specific embodiment of the fixture 72 for displaying the system 10.

The fluid may be located within, may be housed within and/or may be stored within a container 74 as shown in FIGS. 1-3. The container 74 may be, for example, a bag, a sleeve, a box, a can, a pouch, a ball and/or the like. The container may have an outlet 76 as shown in FIGS. 1 and 3. A hose 78 may be attached to and/or may be connected to the outlet 76 by the user for dispensing the fluid with the container 74. The hose 78 may extend outwardly with respect to the outlet 76 of the container 74. In an embodiment, the hose 78 may be affixed to the container 74 before the container 74 may be distributed to and/or received by the user. The hose 78 may have a tip 80 which may be located opposite to the outlet 76 of the container 74. The container may provide a sterile and uncontaminated environment for storing and/or for dispensing the fluid via the hose 78. In an embodiment, the hose 78 may be integrally formed with the container 74 and/or the outlet 76.

The tip 80 of the hose 78 may be closed, may be sealed and/or may be shut for storing the fluid within the container 74 in a sterile environment and/or uncontaminated environment. Alternatively, the tip 80 of the hose 78 may be opened and/or may be unsealed for dispensing and/or for releasing the fluid from the container 74 via the hose 78. The tip 80 of the hose 78 may be cut and may be removed to open the tip 80 of the hose 78 for dispensing and/or for releasing the fluid from the container 74. The container 74 and/or the hose 78 may maintain and/or may maximize a sterility of the fluid which is located within the hose 78 and/or the container 74. The container 74 may be any container for storing, for housing and/or for dispensing the fluid as known to one having ordinary skill in the art.

The fluid may be, for example, a liquid beverage which may be consumable by the user. In an embodiment, the fluid may be, for example, a low acid liquid food product, a dairy-based beverage, a coffee-based beverage and/or the like. Sterility of the fluid within the hose 78 and/or the container 74 may be required for dispensing and/or for serving the fluid to the user to comply with health regulations from a government agency and/or an entity. In an embodiment, the fluid may be aseptically packaged and/or may be aseptically stored within the container 74 for dispensing from, for serving from and/or for releasing from the container 74 via the hose 78. In an embodiment, the fluid located within the container 74 and/or the hose 78 may be sterilized during packaging and/or may remain sterilized until the tip 80 of the hose 78 may be opened, may be unsealed and/or may be removed from the hose 78 of the container 74.

In an embodiment, the fluid within the container 74 and the hose 78 may be an aseptic liquid food product until after the fluid may exit the tip 80 of the hose 78. When the container 74 and/or the fluid within the container 74 may be sterile, the fluid may be served, may be dispensed and/or may be released from the container 74 at, for example, a temperature below room temperature, at room temperature and/or at a temperature above room temperature. As a result, the container 74 and/or the fluid may not require refrigerating and/or heating prior to dispensing, to serving and/or to releasing the fluid from the container 74 via the hose 78.

The hose 78 may have, for example, an antimicrobial hose or a non-microbial hose. In an embodiment, the hose 78 may be made from a material having, for example, antimicrobial properties, antibacterial properties, antifungal properties, anti-algistatic properties and/or the like. In an embodiment, the hose 78 may be made from, for example, an anti-microbial polymer having a zirconium phosphate-based ceramic ion-exchange resin which may contain silver. In an embodiment, the hose 78 may be made from a material which may be, for example, registered with the U.S. Food and Drug Administration for contacting with food and/or for packaging of food. In an embodiment, the hose 78 may inhibit, may prevent and/or may reduce formation, growth and/or migration of microorganisms, such as, for example, bacteria, fungi, algae, microbes, slime, mildew and/or the like within the hose 78. The present invention should not be deemed as limited to a specific embodiment of a microorganism which may be inhibited by the hose 78.

The system 10 may have a clamping device 82 which may be located within and/or may be positioned within the interior 70 of the housing 16 as shown in FIGS. 1-3. In an embodiment, the clamping device 82 may be, for example, a peristaltic pump, a rotational pump and/or the like. The clamping device 82 may have a wheel 84, a guard 86 and/or a block 88. The guard 86 and/or the block 88 may be attached to and/or may be connected to the housing 16. The guard 86 of the clamping device 82 may be located and/or may be positioned adjacent to the first wall 58 of the housing 16. The block 88 may be located and/or may be positioned adjacent to the second wall 60 of the housing 16.

The wheel 84 of the clamping device 82 may be attached to and/or may be connected to the housing 16 via a bolt 90 as shown in FIG. 1. The wheel 84 may be located between the guard 86 and the block 88 within the interior 79 of the housing 16 as shown in FIGS. 1-3. The wheel 84 may be removed from and/or may be separated from the housing 16 via the bolt 90 to repair and/or to maintain the clamping device 82. The wheel 84 may have a front face 92 and a rear face 94 which may be connected via rollers 96a-96f. It should be understood that the number of rollers of the wheel 84 may be any number of rollers as known to one of ordinary skill in the art.

The clamping device 82 may have a groove 98 and/or an arm 100 as shown in FIG. 3. The arm 100 may move and/or may be rotated between an open position in the groove 98 and a closed position in the groove 98 as shown in FIGS. 1-3. As the arm 100 may move and/or may rotate from the open position to the closed position, the block 88 of the clamping device 82 may move inwardly with respect to the guard 86 and/or the wheel 84 of the clamping device 82. In the closed position, the block 88 may be located adjacent to at least two of the rollers 96a-96f of the clamping device 82 and/or the guard 86 of the clamping device 82 as shown in FIG. 2. As the arm 100 may move and/or may rotate from the closed position to the open position, the block 88 of the clamping device 82 may move outwardly with respect to the guard 86 and/or the wheel 84 of the clamping device 82. In the open position, the block 88 may be separated from the guard 86 and/or the wheel 84 as shown in FIGS. 1 and 3.

The container 74 may be positioned within and/or may be located within the compartment 46 of the housing 16 for dispensing, for serving and/or for releasing fluid from the container 74 via the hose 78 as shown in FIGS. 1-3. The outlet 76 of the container 74 may be located and/or may be positioned adjacent to the bottom end 38 of the housing 16, the clamping device 82 and/or the interior 50 of the housing 16. The hose 78 of the container 74 may extend outwardly with respect to the slot 48 of the front wall 44 of the housing 16 and/or with respect to the opening 52 in the bottom end 38 of the housing 16. As a result, the hose 78 of the container 74 may extend outwardly from the compartment 46 of the housing 16 into the interior 50 of the housing 16.

The arm 100 may be moved to the open position via the groove 98 of the clamping device 82 for separating the block 88 from the wheel 84 and/or the guard 82 as shown in FIGS. 1 and 3. The hose 78 of the container 74 may be located between and/or may be positioned between the block 88 and the wheel 84 and/or the guard 82 of the clamping device 82. The hose 78 may extend outwardly from the interior 50 of the housing 16 into the interior 66 of the cap 62 as shown in FIGS. 1-3. The hose 78 may extend through the interior 66 of the cap 62 outwardly with respect to the nozzle 70. As a result, the tip 80 of the hose 78 may be located between and/or may be positioned between the nozzle 70 and the recession 24 on the top side 22 of the base 12 for dispensing and/or for releasing the fluid from the container 74 via the hose 78.

The arm 100 may be moved to the closed position via the groove 98 of the clamping device 82 for moving the block 88 inwardly with respect to the hose 78, the wheel 84 and/or the guard 86 within the interior 50 of the housing 16 as shown in FIG. 2. As a result, the block 88 and/or the wheel 84 of the clamping device 82 may contact and/or may abut the hose 78 of the container 74 to apply a force inwardly with respect to the hose 78 within the clamping device 82 and/or between the block 88 and the guard 82 and/or the wheel 84. In an embodiment, at least two of the rollers 96a-96f and/or the wheel 84 may pinch, may squeeze and/or may clamp the hose 78 by applying the force against the hose 78 within the clamping device 82 in the closed position. As a result, the hose 78 of the container 74 may be closed, may be sealed and/or may be shut with at least two of the rollers 96a-96f and/or the wheel 84 within the clamping device 82.

In an embodiment, the clamping device 82 may not have the rollers 96a-96f for pinching, for squeezing and/or for clamping the hose 78 within the clamping device 82. In the closed position, the wheel 84 and the block 88 may pinch, may squeeze and/or may clamp the hose 78 by applying the force against the hose 78 within the clamping device 82. As a result, the hose 78 of the container 74 may be closed, may be sealed and/or may be shut via the wheel 84 and the block 88 within the clamping device 82.

In the closed position, the fluid within the hose 78 of the container 74 may be located between the container 74 and at least one of the rollers 96a-96f which may be adjacent to the outlet 76 of the container 74. In an embodiment, a downward force, such as, for example, gravity may move and/or may push the fluid from the container 74 in to the hose 78 via the outlet 76. Further, the fluid within the hose 78 may be located between at least two of the rollers 96a-96f which may be adjacent to the block 88 of the clamping device 82. Moreover, the fluid within the hose 78 may be located between the tip 80 of the hose 78 and at least one of the rollers 96a-96f which may be adjacent to the cap 62 of the housing 18 and/or the block 88 of the clamping device 82.

The tip 80 of the hose 78 may be opened and/or may be unsealed to dispense, to serve and/or to release the fluid from the container 74 via the hose 78. In an embodiment, the tip 80 of the hose 78 may be removed, may be snipped away from and/or may be cut from the hose 78. As a result, the fluid between the clamping device 82 and the tip 80 of the hose 78 may be dispensed from and/or may be released from the hose 78. The hose 78 may be closed and/or may be shut by one or more of the rollers 96a-96f of the wheel 84 and/or the block 88 which may clamp and/or may close the hose 78 within the clamping device 82. As a result, the fluid within the hose 78 between at least one of the rollers 96a-96f and/or the block 88 may be prevented from being dispensed and/or from being released from the tip 80 of the hose 78.

At least one of the rollers 96a-96f of the clamping device 82 and/or the block 88 may clamp and/or may close the hose 78 to prevent back flow of the fluid within the hose 78 from at least one of the rollers 96a-96f of the clamping device 82 into the container 74. In an embodiment, the clamping device 82 may be, for example, a stopper that may be insertable into and/or may be removably attached to the tip 80 of the hose 78 for closing and/or for opening the hose 78 to dispense the fluid within the hose 78. The hose 78 may prevent and/or may inhibit growth of and/or migration of the microorganisms within the hose 78 between the tip 80 of the hose 78 and the outlet 76 of the container 74. At least one of the rollers 96a-96f of the clamping device 82 may prevent migration of the microorganisms within the hose 78 between at least one of the rollers 96a-96f and the outlet 76 of the container 74. As a result, the clamping device 82 may prevent migration of the microorganism from the hose 78 into the outlet 76 of the container 74.

The clamping device 82 and/or the hose 78 may prevent contamination of the fluid within the hose 78 and/or within the container 74. The fluid within the hose 78 and/or the fluid within the container 74 may be sterile and/or may be uncontaminated when the tip 80 of the hose 78 may be opened, may be unsealed and/or may be removed via the clamping device 82 and/or the hose 78. The fluid within the hose 78 and/or the container 74 may be sterilized and/or may not be contaminated, the fluid may be dispensed, may be served and/or may be consumable by a user at room temperature. As a result, the system 10 may maintain sterility and/or uncontaminated of the fluid within the hose 78 and/or the container 74 to dispense, to serve and/or to release the fluid at room temperature for consumption by the user and/or a customer (not shown in the figures).

A first amount (not shown in the figures) of the fluid may enter the clamping device 82 from the container 74 via the hose 78 for dispensing and/or for releasing the amount of the fluid from the system 10. The first amount of the fluid may be located within the hose 78 between two of the rollers 96a-96f and the block 88. The wheel 84 may rotate in, for example, a clockwise direction to move and/or to push the first amount of the fluid within the hose 78 between two or more of the rollers 96a-96f towards the tip 80 of the hose 78. The first amount of the fluid may exit from and/or may be released from the hose 78 via the tip 80 of the hose 78. As a result, the first amount of the fluid within the hose 78 may pass through the clamping device 82 from the outlet 76 of the container 74 to the tip 80 of the hose 78 via two or more rollers 96a-96f of the wheel 84.

As the wheel 84 may rotate, a second amount (not shown in the figures) of the fluid may enter the clamping device 82 as the first amount of fluid may have been dispensed from the clamping device 82. The wheel 84 may rotate to move and/or to push the second amount of fluid within the hose 78 between at least two of the rollers 96a-96f. The wheel 84 may rotate, and the second amount of the fluid within the hose 78 may exit from and/or may be released from the tip 80 of the hose 78. As a result, the second amount of the fluid may pass through and/or may move through the clamping device 82 for dispensing and/or for releasing the second amount of the fluid from the container 74 via the hose 78. The first amount and/or the second amount of the fluid may have a first volume, such as, for example, less than three (3) ounces. It should be understood that the first volume of the first amount of the fluid may be any volume as known to one having ordinary skill in the art.

The wheel 84 of the clamping device 82 may rotate to dispense and/or to release additional amounts (not shown in the figures) of the fluid after the first amount of and the second amount of the fluid may have been dispensed and/or may have been released from the container 74 via the hose 78. As a result, a portion (not shown in the figures) of the fluid may be dispensed and/or may be released from the container 74 via the clamping device 82 and/or the hose 78. In an embodiment, the portion may have a second volume, such as, for example, eight (8) ounces, twelve (12) ounces, sixteen (16) ounces, twenty-four (24) ounces or thirty-six (36) ounces. The present invention should not be deemed as limited to a specific embodiment of the second volume of the portion of the fluid which may be dispensed and/or may be released from the system 10 via the clamping device 82 and/or the container 74.

The lid 56 may be inserted in the groove 54 of the housing 16 for attaching and/or for connecting the lid 56 to the system 10. The first wall 58 and/or the second wall 60 of the lid 56 may enclose and/or may cover the container 74, the compartment 46 of the housing 16, the clamping device 82 and/or the interior 50 of the housing 16. As a result, the container 74 may be sealed within the compartment 46 of the housing 16. The lid 56 may be removed from the groove 54 of the housing 16 for removing and/or for replacing the container 74. In an embodiment, the fluid may be emptied from and/or may be drained from the container 74 by dispensing and/or by releasing additional portions of the fluid via the clamping device 82 and/or the hose 78 of the container 74. When the container 74 may be emptied of and/or may be drained of the fluid, the container 74 may be removed from the compartment 46 of the housing 16 and/or may be replaced by additional containers (not shown in the figures).

A vessel (not shown in the figures) may be positioned and/or may be located within the recession 24 of the base 14 for receiving and/or for serving the first amount of, the second amount of and/or the portion of the fluid which may be released, may be served and/or may be dispensed from the tip 80 of the hose 78. The vessel may be located between the hose 78 and the top side 22 of the base 12. The tip 80 of the hose 78 may be aligned with and/or may be positioned above the vessel on the base 12. The first amount of, the second amount of and/or the portion of the fluid from the hose 78 and/or from the container 74 may be released from, may be dispensed from and/or may exit the hose 78 to be received by the vessel via the hose 78 and/or the clamping device 82. The vessel may be sized to receive and/or to store the first amount of, the second amount of and/or the portion of the fluid which may be dispensed and/or may be released from the tip 80 of the hose 78. The first amount of, the second amount of and/or the portion of the fluid may be served to the user and/or the customer in the vessel from the system 10 via the hose 78 and/or the clamping device 82.

The user and/or the customer may press the button 26 on the base 12 to activate the clamping device 82 of the system 10 for dispensing, for serving and/or for releasing the fluid within the hose 74 from the container 74 via the tip 80 of the hose 74. The user and/or the customer may depress the button 26 to deactivate the clamping device 82 for preventing and/or for stopping the fluid from being dispensed and/or from being released from the tip 80 of the hose 74. The wheel 84 may be connected to a motor (not shown in the figures) of the clamping device 82 for rotating and/or for turning the wheel 84 to move and/or to push the fluid within the hose 78 through the clamping device 82 from at least one of the rollers 96a-96f of the wheel 84 from the tip 80 of the hose 78. The button 26 may activate and/or may deactivate the motor for rotating the wheel 74 to dispense, to serve and/or to release the fluid within the hose 78 between at least one of the rollers 96a-96f and the tip 80 of the hose 78.

The hose 78 may inhibit, may prevent and/or may reduce growth of the microorganisms within the hose 78 as the fluid within the hose 78 may be dispensed and/or may be released from the tip 80 of the hose 78. The hose 78 may inhibit, may prevent and/or may reduce growth of the microorganisms within the hose 78 when the fluid may not be within the hose 78. The hose 78 may inhibit, may prevent and/or may reduce mitigation of the microorganisms within the hose 78 between the outlet 76 of the container 74 and the tip 80 of the hose 78. The hose 78 and/or the clamping device 82 may prevent growth and/or mitigation of the microorganisms within the hose 78 and/or the container 80. As a result, a hot water flush of the hose 78 may not be required to remove and/or to clean microorganisms from the hose 78. The hose 78, the fluid and/or the container 74 may maintain sterilization and/or an uncontaminated state without flushing hot water into the hose 78.

The hose 78 may prevent and/or may reduce contamination of the fluid within the hose 78 and/or the container 74 from the microorganisms. The fluid and/or the container may be sterile and/or may be uncontaminated for dispensing and/or for releasing the fluid from the tip 80 of the hose 78. As a result, the first amount of, the second amount of and/or the portion of the fluid may be dispensed into, may be served into and/or may be released into the vessel at a first temperature. The first temperature may be, for example, room temperature, a temperature above room temperature or a temperature below room temperature. The fluid which may be dispensed into, may be served into and/or may be released into the vessel at the first temperature may be sterile and/or may be uncontaminated for consumption by the user and/or the consumer.

In an embodiment, the system 10 may have a temperature element 200 attached to and/or connected to the housing 16 and/or the cap 62 as shown in FIG. 2. The temperature element 200 may be, for example, a heating element or a refrigeration unit. The temperature element 200 may be located and/or may be positioned within the interior 70 of the cap 62 for heating or for cooling the hose 78 between the clamping device 82 and/or the tip 80 of the hose 78. The hose 78 may extend through and/or may pass through the temperature element 200 to heat or to cool the hose 78 before and/or after the fluid within the hose 80 which may exit the tip 80 of the hose 78. The temperature element 200 may surround and/or may enclose the hose 78 adjacent to the clamping device 82 between the tip 80 of the hose 78 and the clamping device 82. In an embodiment, the temperature element 200 may heat or otherwise radiate heat against the hose 78 to heat the hose 78 to dispense, to serve and/or to dispense the first amount of, the second amount of and/or the portion of the fluid. In an embodiment, the temperature element 200 may cool the hose 78 to dispense, to serve and/or to dispense the first amount of, the second amount of and/or the portion of the fluid. As a result, the tip 80 of the hose 78 may dispense, may serve and/or may release the first amount of, the second amount of and/or the portion of the fluid into the vessel for consumption by the user and/or the customer.

Heating and/or cooling the hose 78 by the temperature element 200 may prevent and/or may reduce growth and/or migration of the microorganisms within the hose 78. Additionally, temperature element 200 may destroy and/or may eliminate the microorganisms which may be located within the hose 78 between the clamping device 82 and the tip 80 of the hose 78. As a result, the temperature element 200 may sterilize the hose 78 between the clamping device 82 and the tip 80 of the hose 78. The fluid may exit the clamping device 82 and enter the hose 78 which may be sterilized and/or may be uncontaminated by the temperature element 200. As a result, the temperature element 200 may prevent contamination of the fluid and/or the hose 78 to dispense, to serve and/or to release the fluid for consumption by the consumer and/or the user.

The system 10 may dispense and/or may release the fluid from the container 74 via the hose 78 of the container 74. The hose 78 may extend through the clamping device 82 between the wheel 84 and the block 86 of the clamping device 82. At least one of the rollers 96a-96f may pinch and/or may clamp the hose 78 to close or to seal the hose 78 between at least one of the rollers 96a-96f and the outlet 76 of the container 74. As a result, the rollers 96a-96f, clamping device 82 and/or gravity prevent back flow of the fluid from the hose 78 into the container 74 for maintaining the sterility of the fluid within the hose 78 and/or within the container 74. The wheel 84 of the clamping device 82 may rotate to move and/or displace the fluid within the hose 78 and/or the container 74 into a vessel which may be located in the recession 24 of the base 12. The hose 78 may have antimicrobial properties and/or antibacterial properties to inhibit growth and/or migration of the microorganisms within the hose.

The rollers 96a-96f and/or the clamping device 82 may prevent migration of the microorganisms from the hose 78 into the container 74. The fluid within the hose 78 and/or within the container 74 may be sterile and uncontaminated by the microorganisms when the tip 80 of the hose 78 may be opened and/or may be removed to dispense the fluid via the hose 78. The system 10 may have the temperature element 200 for heating and/or for cooling the hose 78 adjacent to the temperature element 200. The hose 78, the clamping device 82 and/or the temperature element 200 may prevent and/or may reduce contamination of the fluid for dispensing and/or for serving to the user and/or the customer via the vessel.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for dispensing a fluid, the system comprising:
a container having exterior walls defining an interior wherein the fluid is aseptically stored within the interior of the container wherein the container has a hose having a length defined between the exterior walls of the container and a tip of the hose wherein the hose extends outwardly with respect to the exterior walls of the container wherein the fluid is dispensable from the interior of the container via the hose; and
a clamping device connected to the hose between the exterior walls of the container and the tip of the hose wherein the clamping device has a length defined between a first end and a second end wherein the first end of the clamping device is adjacent to the container wherein the hose of the container extends through the clamping device outwardly with respect to the second end of the clamping device wherein the clamping device closes the hose at a position within the clamping device wherein the clamping device dispenses a portion of the fluid from the tip of the hose and further wherein the fluid is aseptic.

2. The system of claim 1 wherein the fluid is a liquid food product, a dairy-based beverage or a coffee-based beverage.

3. The system of claim 1 further comprising:
a housing connected to the clamping device wherein the housing has an interior which is sized to receive the container.

4. The system of claim 1 further comprising:
a heating element connected to the hose wherein the heating element heats the fluid dispensed from the hose.

5. The system of claim 1 further comprising:
an outlet located between the interior of the container and the hose wherein the fluid is dispensed from the interior of the container via the outlet.

6. The system of claim 1 wherein the hose is made from an antimicrobial material.

7. A method for dispensing a fluid, the method comprising the steps of:
providing a container having exterior walls defining an interior wherein the exterior walls have an outlet wherein the interior of the container is accessible via the outlet wherein the fluid is aseptically stored within the interior of the container; and
connecting a hose to the outlet of the container wherein the hose has a length defined between a first end and a second end wherein the first end of the hose is adjacent to the outlet wherein the second end of the hose extends outwardly with respect to the exterior walls of the container wherein the fluid is dispensable from the interior of the container via the hose wherein the hose prevents contamination of the fluid.

8. The method of claim 7 further comprising the step of:
opening the second end of the hose wherein the fluid within the hose and the interior of the container is aseptic.

9. The method of claim 7 further comprising the step of:
changing a temperature of the hose between the first end of the hose and the second end of the hose.

10. The method of claim 7 wherein the hose is made from an antimicrobial material.

11. The method of claim 7 further comprising the step of:
dispensing a first portion of the fluid within the hose via the second end of the hose wherein the fluid is aseptic.

12. The method of claim 7 further comprising the step of:
connecting a clamping device to the hose wherein the clamping device is located between the first end of the hose and the second end of the hose.

13. The method of claim 7 further comprising the step of:
connecting a housing to the container wherein the housing has an interior which is sized to receive the container.

14. The method of claim 7 further comprising the step of:
closing the hose at a position which is located between the first end of the hose and the second end of the hose.

15. A method for dispensing a fluid from a container wherein the container has exterior walls defining an interior of the container wherein the container has an outlet wherein the fluid exits the interior of the compartment via the outlet wherein the fluid is a food product which is aseptically stored within the interior of the container, the method comprising the steps of:
connecting a hose to the outlet of the container wherein the hose has a length defined between a first end and a second end wherein the first end of the hose is adjacent to the container wherein the second end of the hose extends outwardly with respect to the outlet of the container wherein the second end of the hose is open and further wherein the fluid is dispensable via the second end of the hose;
closing the hose at a point along the length of the hose wherein the point is located between the first end of the hose and the second end of the hose; and
dispensing a portion of the fluid within the hose via the second end of the hose wherein the fluid within the hose and the interior of the container is aseptic.

16. The method of claim 15 further comprising the step of:
connecting a clamping device to the hose wherein the clamping device dispenses the fluid from the hose.

17. The method of claim 15 wherein the hose is made from an antimicrobial material.

18. The method of claim 15 further comprising the step of:
closing the second end of the hose wherein the second end of the hose prevents the fluid from exiting the hose.

19. The method of claim 15 further comprising the step of:
connecting a housing to the container wherein the housing has an interior which is sized to receive the container.

20. The method of claim 15 further comprising the step of:
emptying the fluid from the interior of the container via the hose.
